(19) United States
(12) Patent Application Publication
(10) Pub. No.: US 2014/0363351 A1
(43) Pub. Date: Dec. 11, 2014

(54) RENEWABLE ENERGY CONVERSION AND STORAGE EQUIPMENT

(71) Applicant: HITACHI, LTD., Tokyo (JP)

(72) Inventor: Masatoshi Sugimasa, Tokyo (JP)

(21) Appl. No.: 14/369,445

(22) PCT Filed: Dec. 3, 2012
(86) PCT No.: PCT/JP2012/081230

§ 371 Date: Jun. 27, 2014

(30) Foreign Application Priority Data
Dec. 28, 2011 (JP) 2011-287260

(51) Int. Cl. C25B 1/04; C07B 35/02

(52) U.S. Cl. CPC C25B 1/04; C07B 35/02
USPC 422/187; 204/242

(57) ABSTRACT

An objective of the present invention is to provide an energy conversion and storage equipment which is capable of efficiently generating hydrogen using varying electric power generated from renewable energy and is capable of storing the hydrogen. The invention is an apparatus for converting and storing renewable energy in which hydrogen is produced with a water electrolysis device using the varying electric power generated in renewable-energy equipment and the hydrogen is stored, the apparatus being characterized in that the water electrolysis device includes an oxygen generation electrode which comprises an Ir—Mn alloy oxide. Due to the application of the electrode, with which water can be electrolyzed using the varying electric power generated from renewable energy, the system suffers little electrode deterioration even when the varying electric power is used, and it is possible to highly efficiently produce and store hydrogen for a long period.

### FIELD OF INVENTION

The present invention relates to a system to convert renewable energy to hydrogen energy to be stored.

### BACKGROUND OF INVENTION

In recent years, since many people think that exhaustion of resources and destruction of the environment are serious issues for the earth, it is required that a zero emission society utilizing renewable energy be built. In order to realize the zero emission society, utilization of such natural resources of wind power and sunlight as well as other energy that has not been utilized is recommended. Moreover, more attention is paid to hydrogen with which only water is exhausted when used, as an alternative energy to fossil energy.

Hydrogen exists as water molecules or hydrocarbons in any place of the world and its resource amount is as good as unlimited. In addition, since hydrogen can be produced in various methods and is produced in an appropriate method depending on the circumstance of a local area, hydrogen has an advantage over fossil fuel which is unevenly distributed in the world and could be exhausted.

Development of fuel cells for hydrogen automobile vehicles, fuel cell automobile vehicles and distributed power sources has been under way to utilize hydrogen. On the other hand, it is necessary to build such an infrastructure for supplying hydrogen as including hydrogen stations in order to support hydrogen utilization techniques. Especially there are various types of hydrogen stations. One of the various type of the hydrogen stations makes use of a method of supplying hydrogen gas that is compressed or physically adsorbed and stored. One makes use of a method of storing and supplying hydrogen liquid into which hydrogen gas is converted after being cooled. The other makes use of a method of supplying hydrogen that is produced through a reforming device from chemically hydrogen stored compound such as natural gas.

For example, a patent document 1 proposes a hydrogen supply system, a hydrogen storage station structure and a hydrogen transport vehicle, which enable safely transporting a large amount of hydrogen by having a hydrogen absorption alloy absorb hydrogen and transporting this hydrogen absorbed alloy on a vehicle.

A patent document 2 proposes a hydrogen storage/supply system, a hydrogen storage/supply device and a catalyst for hydrogen storage and supply. This hydrogen storage/supply system is meant to store and supply hydrogen utilizing a hydrogenation reaction and a dehydrogenation reaction between a hydrogen storing material of an aromatic compound such as benzene to store hydrogen and a hydrogen supplying material such as cyclohexane that is to convert to the aromatic compound after hydrogen is removed therefrom. This hydrogen storage/supply system comprises a hydrogen reaction device equipped with a heater for heating the hydrogen storing material or the hydrogen supplying material before the hydrogenation reaction or the dehydrogenation reaction, a hydrogen supply device to supply the hydrogen reaction device with hydrogen and a power generation device such as a fuel cell for generating electric power from the hydrogen produced with the hydrogen reaction device, with which the reaction efficiency of the hydrogenation reaction or the dehydrogenation reaction is enhanced.

A patent document 3 proposes a method for increasing thermal efficiency of the hydrogen station of the hydrogen storage and supply system which stores and supplies hydrogen making use of a hydrogenation reaction and a dehydrogenation reaction between a dehydrogenated material of the aromatic compound such as benzene to be hydrogenated and a hydrogen supplying material such as cyclohexane that is to convert to the aromatic compound after hydrogen is removed therefrom. In this method, a partial or total amount of heat that is needed for the dehydrogenation reaction is supplied from exhaust heat of high temperature exhaust gas exhausted from a combustion turbine power generator while electrical power needed for such an incidental facility as a hydrogen compressor is supplied from generated power of the combustion turbine power generator.

### PRIOR ART DOCUMENT

### Patent Document

Patent Document 1: JPH07-112796A

Patent Document 2: JP2002-184436A

Patent Document 3: JP2004-197705A

### SUMMARY OF THE INVENTION

### Objective to be Achieved by the Invention

As has been explained, hydrogen exists in various forms and can be produced with various methods. At present a hydrogen production method of steam reforming of fossil fuel is most commonly and carbon dioxide is discharged during this hydrogen production. Hydrogen can be produced through water electrolysis and gas of only hydrogen and oxygen is discharged during this electrolysis process. However, if input electric power to the electrolysis comes from electric power generated by a thermal power generation apparatus, carbon dioxide gas is discharged during the hydrogen production.

On the other hand, when water is electrolyzed with power generated from renewable energy generated by a wind power generation apparatus or a solar photovoltaic power generation apparatus, only a very small amount of carbon dioxide gas is discharged during the hydrogen production. However, the generated power from these renewable energy power generation apparatus varies so much that there is a problem with an excessive load being applied to the electrolysis apparatus which could cause deterioration of the electrode if the varying electric power is supplied to the electrolysis apparatus without any modification.

It has been difficult to efficiently produce and store hydrogen using varying electric power derived from renewable energy.

The present invention is intended to provide energy conversion and storage equipment which enables efficiently producing hydrogen using varying electric power generated by a renewable energy generation apparatus and storing the produced hydrogen.

### Means to Achieve the Objective

In order to achieve the above mentioned objective, the present invention has a following feature.

The present invention has the feature of a oxygen evolution electrode being made of an Ir—Mn alloy oxide in an electrolytic device with which hydrogen is produced and stored by utilizing varying electric power generated by a renewable energy generation apparatus.

### Effect of the Invention

The present invention provides an energy conversion and storage equipment that enables efficiently producing and storing hydrogen making use of varying electric power generated from renewable energy.

### BRIEF EXPLANATION OF DRAWINGS

FIG. 1 is a schematic diagram for a configuration of an energy conversion and storage system of an example of the present invention.

FIG. 2 shows a relation between an oxygen evolution current on the Ir—Mn alloy oxide and the Mn content ratio to the Ir content.

FIGS. 3A, 3B show X-ray diffraction results measured on an Ir—Mn alloy oxide.

FIG. 4 shows a relation between the oxygen evolution current at the Ir—Mn alloy oxide and the voltage cycle.

### EMBODIMENT FOR PRACTICING THE INVENTION

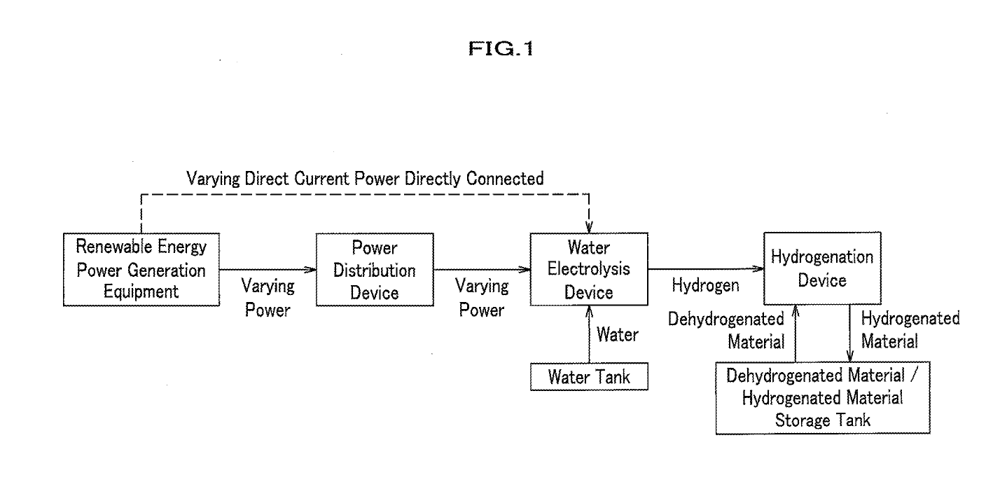

FIG. 1 is a schematic diagram for a configuration of an energy conversion and storage system of an example of the present invention. The energy conversion and storage system of this example is configured to comprise a renewable energy power generation equipment (Renewable Energy P. G. E), a power distribution device, a water electrolysis device to electrolyze water into hydrogen and oxygen using varying electric power, a water tank to supply water to the water electrolysis device, a hydrogenation device for coupling the hydrogen supplied from the water electrolysis device to liquid organic compounds and a storage tank to store the organic compounds with which the hydrogen is coupled.

The renewable energy power generation apparatus may be based on wind power generation, solar photovoltaic power generation, solar heat power generation and hydroelectric power generation and of any type of the power generation apparatus that does not discharge carbon dioxide. For example, an internal combustion power generation apparatus that makes use of any of biomass and bioethanol which is produced from wood chips or fermentation gas and substantially does not discharge carbon dioxide may be used for the present invention. Electrical power generated from the renewable energy power generation apparatus is transmitted to the power distribution device. The generated power is varying electric power.

The power distribution device has a function of converting the transmitted power to direct current power and suppling the direct current power to the water electrolysis device. The power distribution device has only to supply the direct current power to the water electrolysis device and does not need any electricity storage device to level the supplied power such as a super-capacitor or a secondary battery. If a solar photovoltaic power generation apparatus which is capable of generating direct current power is used, the renewable energy power generation apparatus and the water electrolysis device may be directly connected with each other with no power distribution device included. As a result, the energy conversion and storage equipment of the example of the present invention has a configuration in which the varying electric power that is generated by renewable energy power generation apparatus is supplied to the water electrolysis device. This configuration does not need an electricity storage device such as a super-capacitor or a secondary battery to level the electric power and enables simplifying the system and reducing the cost.

There are various types of water electrolysis devices which are different in an electrolyte that is used. For example, there are water electrolysis devices of an alkali water type, a solid polymer type and a solid oxide type and the water electrolysis device of any type will do as long as it is capable of electrolyzing water with varying electric power. If the water electrolysis device is coupled with such a large scale power generation apparatus as a mega-solar photovoltaic power generation apparatus or a wind farm, an alkali type water electrolysis device is preferable in terms of reliability and cost because it has been successfully applied to many large scale apparatuses. Moreover, a sodium electrolysis device that uses salt water may be used and if it is used, chlorine and sodium solution can sell as raw materials for chemical products.

The hydrogenation device has only to have a function of hydrogenating organic compounds and may be a device being capable of performing a technique that is used for petrochemical plants. Preferable hydrogenated materials are hydrocarbon type fuels and hydrocarbon included fuels which are produced easily through hydrogenation, such as cyclohexane, methylcyclohexane and decaline. When methylcyclohexane is used as a hydrogen storage material (hydrogenated material), a hydrogenating reaction is represented by the equation (1) as follows.

C₇H₆ (Toluene)+3 H₂ (Hydrogen)→C₇H₁₄ (Methylcyclohexane)+205 kJ Equation (1)

The reaction of the equation (1) is an exothermic reaction and progresses automatically once toluene and hydrogen are introduced into the hydrogenating device in which a catalyst is placed. In case the hydrogenating device is not heated up to a sufficiently high temperature, the exhaust heat from the power generation apparatus may be used for heating when the solar heat power generation apparatus or the internal combustion power generation apparatus is used or part of generated electrical power may be applied to heater. When cyclohexane, methylcyclohexane and decaline are used for the hydrogenated materials, the dehydrogenated materials are to be benzene, toluene, and naphtalin. The dehydrogenated materials are stored in tanks each of which is dedicated to one of the hydrogen removed materials and supplied from the tanks to the hydrogenating device, and the hydrogenated materials that are produced are stored in tanks into each of which a hydrogenated material with a predetermined amount of hydrogen to be released. It is easy to store cyclohexane, methylcyclohexane and decaline because these materials are liquid at a room temperature and an ordinary pressure. In addition these hydrocarbon fuels are stock pile products for strategic reasons, have been stored for a long time and transported a long distance and are preferable as storage media for energy.

There are also other forms of storing hydrogen such as storing liquid hydrogen kept cooled and storing compressed hydrogen gas that is pressurized. However, energy is needed to cool or pressurizes hydrogen. Especially when liquid hydrogen that is suited for a large scale storage is used, the energy needed for cooling amounts to 25% of an amount of heat stored hydrogen generates and the stored hydrogen gradually decreases during a long period of storage due to vaporization of liquid hydrogen that is called “boil off”. On the other hand, when organic compounds are hydrogenated and stored, the hydrogenated organic compounds are kept stably stored after efficiently hydrogenated using the exhausted heat. Therefore the hydrogenated organic compounds are preferred to liquid hydrogen and pressurized gas.

The present example is directed to a energy conversion and storage system to produce hydrogen by electrolyzing water making use of varying electric power which is generated from and characteristic for renewable energy. In general, variation of the input electric power may result in deterioration of an electrode and is not preferable. Therefore leveled power is often used for electrolyzing water. However, an electricity storage device such as a secondary battery and power conversion devices, which are costly, are needed to level varying electric power of the renewable energy power generation equipment.

The water electrolysis device in this example has a feature of utilizing an electrode material that does not easily deteriorate even if varying electric power is applied to the water electrolysis device. To be specific, the water electrolysis device has an oxygen evolution electrode to which an alloy oxide of iridium (Ir) and Manganese (Mn) is applied. The oxygen evolution electrode of the present example is produced in the following way.

A pure Ti plate is used for the electrode substrate. The Ti plate was immersed for 45 minutes in 20 wt % oxalic acid solution at 95° C. Subsequently the Ti plate is dipped in butanol solution in which manganese chloride 4 hydrates and hexachloroiridium (IV) n hydrates are dissolved, dried at 160° C. for 30 minutes and fired in the air at 500° C. for 10 minutes to prepare the Ti electrode.

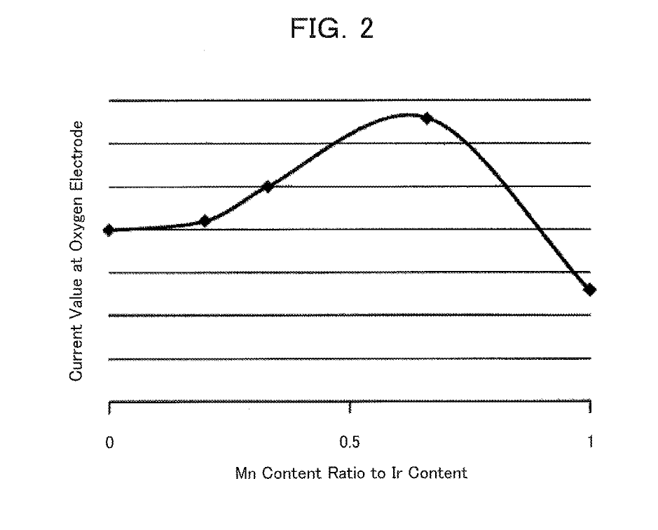

FIG. 2 shows a relation between an oxygen evolution current at the Ir—Mn alloy oxide and the Mn content ratio to the Ir content. The used solution was 3M NaOH aqueous solution. An oxygen evolution current was measured for every sample tested, became larger with a Mn content increasing, the largest when the Mn content ratio to an Ir content is 2:3 and decreases when the Mn content further increased. From these results, the Mn content ratio to the Ir content is preferably 0.2 to 0.9 and more preferably 0.5 to 0.7.

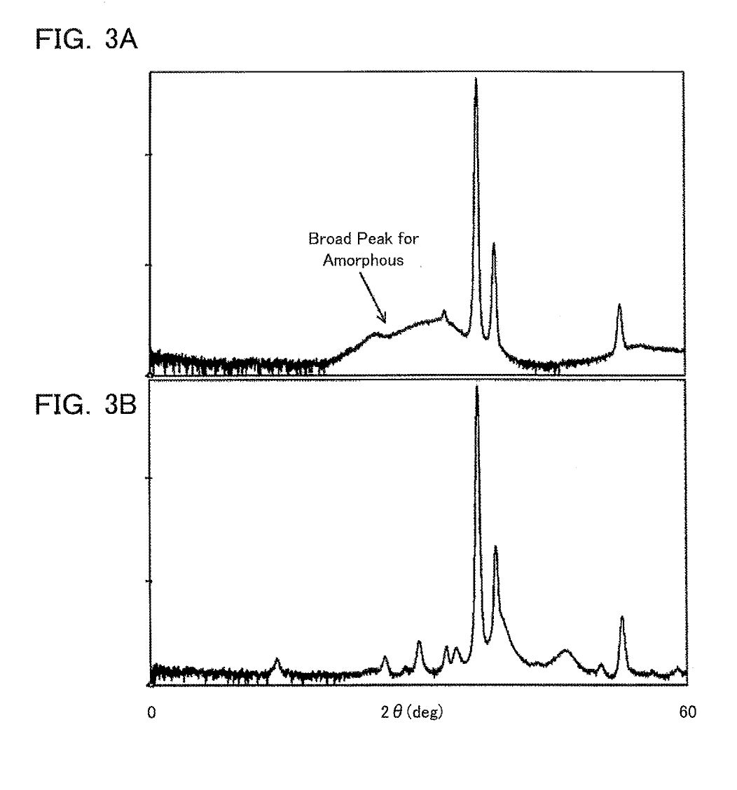

FIG. 3A shows an X-ray diffraction result measured on an Ir—Mn alloy oxide of the present example and FIG. 3B shows an X-ray diffraction result measured on an Ir—Mn alloy oxide of the comparative sample. The Ir—Mn alloy oxide of the comparative example was prepared by firing a Ti plate that is immersed in butanol solution in which a mixture of manganese chloride 4 hydrates and hexachloroiridium (IV) n hydrates. The other conditions were the same as the working sample. A peak for Ti was observed in both measurement results. On the other hand, a peak for Ir—Mn alloy oxide is identified in FIG. 3B and a broad peak indicating a amorphous state is identified for the Ir—Mn alloy oxide of the present invention. These results confirms that the Ir—Mn alloy oxide of the present example is in the amorphous state

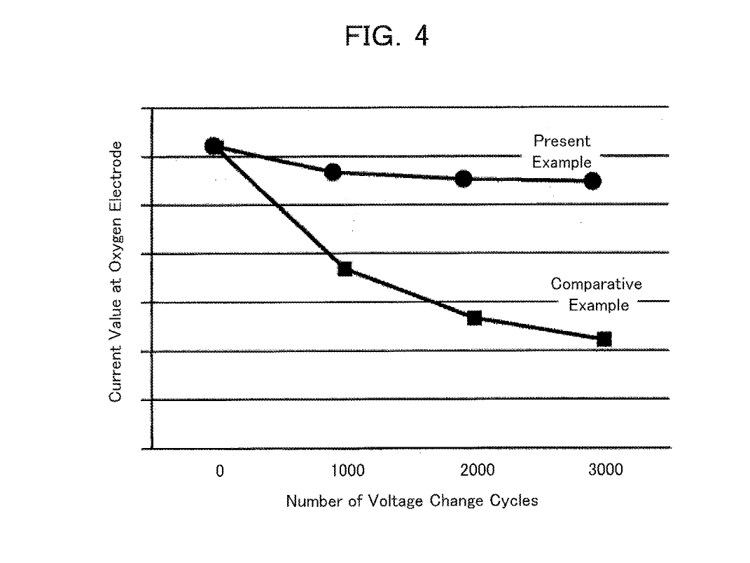

FIG. 4 shows a relation between the oxygen evolution current at the I—Mn alloy oxide and the voltage cycle. The horizontal axis stands for a number of voltage change cycles which simulate variation of the input voltage. The measurement method was to measure an oxygen evolution current at the oxygen evolution electrode to which a predetermined voltage relative to a reference electrode was applied after the voltage variation of 2 V had been applied a predetermined times in 3M NaOH aqueous solution. In addition, in FIG. 4 is indicated a relation between the voltage cycle and the oxygen evolution current at Ir which has been widely used for the oxygen evolution electrode for water electrolysis.

The results in FIG. 4 indicate that the oxygen evolution electrode of the Ir—Mn alloy oxide of the present example enables suppressing the current value lowering due to the voltage cycles compared with Ir that has been used so far.

As has been explained, the energy conversion and storage equipment of the present example, which includes a water electrolysis device having an oxygen electrode inclusive of Ir—Mn alloy oxide to electrolyze water making use of varying electrical power generated from renewable energy, is capable of keeping electrodes with relatively small deterioration when the varying electric power is applied for a long period and efficiently producing and storing hydrogen for a long period.

Moreover, since the renewable energy conversion and storage equipment of the present example enables producing hydrogen with as small an amount of carbon dioxide as possible discharged when hydrogen is produced, an environment friendly system can be built with this energy conversion and storage equipment.

What is claimed:

1. Renewable energy conversion and storage equipment comprising:
renewable energy power generation equipment generating varying electric power, and
a water electrolysis device producing hydrogen from the varying electric power,
wherein the water electrolysis device comprises an oxygen evolution electrode to which an Ir—Mn alloy oxide is applied.

2. The renewable energy conversion and storage equipment as described in claim 1, wherein the Ir—Mn alloy oxide is amorphous.

3. The renewable energy conversion and storage equipment as described in claim 1, wherein the varying electric power generated by the renewable energy power generation equipment is input to the water electrolysis device.

4. The renewable energy conversion and storage equipment as described in claim 3, further comprising a power distribution device for converting the varying electric power generated by the renewable energy power generation equipment to a direct current varying electric power and inputting the direct current varying electric power to the water electrolysis device.

5. The renewable energy conversion and storage equipment as described in claim 4, further comprising a hydrogenation device for hydrogenating and liquidizing an organic compound.

6. The renewable energy conversion and storage equipment as described in claim 1, wherein the renewable energy power generation equipment is capable of generating power through at least one of wind power generation, solar photovoltaic power generation, solar heat power generation and hydroelectric power generation.
